(19) United States
(12) Patent Application Publication
(10) Pub. No.: US 2017/0164412 A1
(43) Pub. Date: Jun. 8, 2017

(54) Method and electronic device for managing connection informaion of wireless network

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Xiaowei YU, Beijing (CN)

(21) Appl. No.: 15/239,128

(22) Filed: Aug. 17, 2016

Related U.S. Application Data
(63) Continuation of application No. PCT/CN2016/088730, filed on Jul. 5, 2016.

(30) Foreign Application Priority Data
Dec. 3, 2015 (CN) 2015108819326

(51) Int. Cl. H04W 76/02; H04L 29/08

(52) U.S. Cl. CPC H04W 76/02; H04L 67/14

(57) ABSTRACT

Disclosed are a method, an electronic device and a non-transitory computer-readable storage medium for managing connection information of a wireless network. The method includes: setting a change time for the connection information of the wireless network; detecting whether a current time arrives at the change time, generating new connection information corresponding to the change time according to a predetermined algorithm in a case that the current time arrives at the change time; replacing original connection information of the wireless network with the new connection information corresponding to the change time; and converting the new connection information into a bar code, so that a terminal device is connected to the wireless network by scanning the bar code.

### CROSS REFERENCE TO RELATED APPLICATIONS

The present application is a continuation of PCT application which has an application number of PCT/CN2016/088730 and was filed on Jul. 5, 2016. This application claims the priority to Chinese Patent Application No. 201510881932.6, entitled “METHOD, DEVICE AND SYSTEM FOR MANAGING CONNECTION INFORMATION OF WIRELESS NETWORK” and filed with the Chinese State Intellectual Property Office on Dec. 3, 2015, which is incorporated herein by reference in its entirety.

### TECHNICAL FIELD

The disclosure relates to the field of communication technology, and particularly to a method, an electronic device and a non-transitory computer-readable storage medium.

### BACKGROUND

In order to avoid a password from being cracked by a hacker or avoid some user from stealing the network indefinitely, connection information such as a name and a password of a wireless network should be changed regularly, to raise security. Currently, an administrator logs onto a setting page for the wireless network, and changes a name and a password of the wireless network to change the connection information of the wireless network in general. However, in this way, not only workload of the administrator is increased, but also the operation is tedious. In addition, the administrator may forget to change the name and the password of the wireless network, then a time period during which a same name and password of the wireless network are used is too long.

### SUMMARY

In view of this, a method for managing connection information of a wireless network, an electronic device for connection information of a wireless network and a non-transitory computer-readable storage medium are provided according to the embodiments of the present disclosure, to overcome or at least partially solve the problems described above.

A method for managing connection information of a wireless network is provided according to an aspect of the embodiments of the present disclosure, the method may include:

setting a change time for the connection information of the wireless network;

detecting whether a current time arrives at the change time, generating new connection information corresponding to the change time according to a predetermined algorithm in a case that the current time arrives at the change time;

replacing original connection information of the wireless network with the new connection information corresponding to the change time; and

converting the new connection information into a bar code, so that a terminal device is connected to the wireless network by scanning the bar code.

Optionally, the method may further include transmitting the bar code to a display device in a preset mode, to display the bar code on the display device, the terminal device being connected to the wireless network by scanning the bar code on the display device.

Optionally, the change time for the connection information is periodical.

Optionally, the connection information may include a name and a password of the wireless network;

changing the connection information may include changing the name of the wireless network and/or changing the password of the wireless network;

where the changing the password of the wireless network may include changing a length of the password or strength of the password of the wireless network.

Optionally, the bar code is a two-dimensional code.

Optionally, the preset mode may include a wireless communication mode and a wire communication mode.

An electronic device for connection information of a wireless network is provided according to another aspect of the embodiments of the present disclosure, the electronic device may include:

at least one processor; and

a memory communicably connected with the at least one processor for storing instructions executable by the at least one processor, wherein execution of the instructions by the at least one processor causes the at least one processor to:

set a change time for the connection information of the wireless network;

detect whether a current time arrives at the change time, and new connection information corresponding to the change time is generated according to a predetermined algorithm in a case that the current time arrives at the change time;

replace original connection information of the wireless network with the new connection information corresponding to the change time;

convert the new connection information into a bar code, so that the terminal device is connected to the wireless network by scanning the bar code.

Optionally, at least one processor also performs the following steps: transmit the bar code to a display device in a preset mode, to display the bar code on the display device, the terminal device being connected to the wireless network by scanning the bar code on the display device.

Optionally, the change time for the connection information is periodical.

Optionally, the connection information may include a name and a password of the wireless network;

changing the connection information may include changing the name of the wireless network and/or changing the password of the wireless network;

where the changing the password of the wireless network may include changing a length of the password or strength of the password of the wireless network.

Optionally, the bar code is a two-dimensional code.

Optionally, the preset mode may include a wireless communication mode and a wire communication mode.

A non-transitory computer-readable storage medium is provided according to another aspect of the embodiments of the present disclosure, and the non-transitory computer-readable storage medium stores executable instructions which can be used to perform any method for managing connection information of a wireless network above;

where the device for managing connection information of a wireless network is configured to transmit the converted bar code to the display device, to display the bar code on the display device.

In the solution according to the embodiments of the present disclosure, with the method provided according to the embodiment of the present disclosure, a change time for the connection information of the wireless network is set, whether a current time arrives at the change time is detected, and new connection information corresponding to the change time is generated according to a predetermined algorithm in a case that the current time arrives at the change time, original connection information of the wireless network is replaced with the new connection information corresponding to the change time, the new connection information is converted into a bar code, so that the terminal device can be connected to the wireless network by scanning the bar code, thereby changing the connection information of the wireless network on time automatically, and saving hand labor, and therefore avoiding limitation of manual change and improving security of the wireless network.

The foregoing are only overview of the technical solution according to the embodiments of the present disclosure, and specific embodiments of the present disclosure are described below, so as to understand the technical solution of the present disclosure more clearly and implement the embodiments according to content of the specification, and make the above and other objectives, features and advantages of the present disclosure clear and easy to be understood.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a method for managing connection information of a wireless network according to an embodiment of the present disclosure;

FIG. 2 is a flow diagram of a method for managing connection information of a wireless network according to another embodiment of the present disclosure;

FIG. 3 is a structural block diagram of a device for managing connection information of a wireless network according to an embodiment of the present disclosure;

FIG. 4 is a structural block diagram of a system for managing connection information of a wireless network according to another embodiment of the present disclosure;

FIG. 5 is a schematic diagram of a hardware structure of an electronic device for implementing a method for managing connection information of a wireless network according to an embodiment of the present disclosure.

### DETAILED DESCRIPTION

The exemplary embodiments of the present disclosure are described in detail below with reference to the drawings. Although the exemplary embodiments of the present disclosure are displayed in the drawings, it should be understood that the present disclosure can be realized in various ways, and is not limited to be realized by the embodiments described here. In contrary, the exemplary embodiments are provided to fully understand the present disclosure and completely convey the scope of the present disclosure to those skilled in the art.

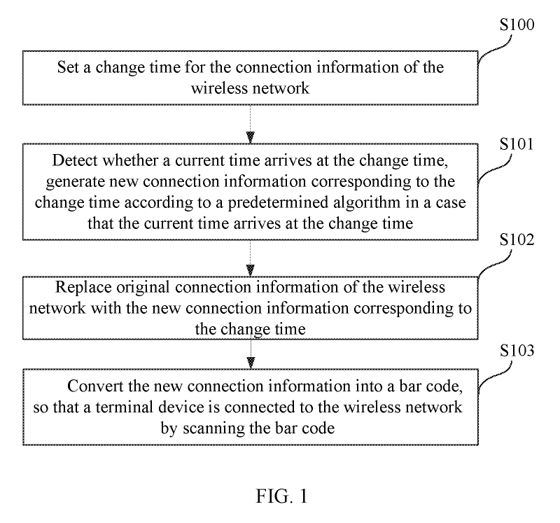

FIG. 1 is a flow diagram of a method for managing connection information of a wireless network according to an embodiment of the present disclosure. As shown in FIG. 1, the method may include steps S100 to S103.

In step S100, a change time for the connection information of the wireless network is set.

In the embodiment, the connection information of the wireless network is information required by a terminal device to connect to a network, and includes a name and a password of the wireless network.

In order to improve security of the wireless network, the connection information of the wireless network is changed. A way of setting the change time for the connection information of the wireless network is used, in this way, the connection information of the wireless network is changed in a case of arriving at the set change time, the change time may be adjusted based on actual cases, and the change time may be preferably set to as a periodical time. For example, the connection information of the wireless network is changed on the first, seventh, 14-th, 21-th or 28-th of each month, or the connection information of the wireless network is changed on Monday of each week, or the connection information of the wireless network is changed at 12:00 am in a day of the change time, or the change time is an unfixed time, which described above are only exemplary, are not intend to limit.

In step S101, whether a current time arrives at the change time, new connection information corresponding to the change time is generated according to a predetermined algorithm in a case that the current time arrives at the change time.

When changing the connection information, only the name of the wireless network or only the password of the wireless network may be changed, or both the name and the password of the wireless network may be changed. Specifically, changing the password of the wireless network may include changing a length of the password or strength of the password of the wireless network.

The strength of the password refers to difficulty of breaking the password by an unauthorized user or a computer. The password may include a weak password and a strong password in general, the weak password includes a short password, a normal password, a system default password, and further includes a password which can be broken by permutations and combinations according to an exhaustion method. These passwords described above may consist of words which may be used as a password, for example, a word in a dictionary, a real name or a word related to a user name, these passwords can be broken fast.

The strong password may have a long length and a random permutation, therefore, it will take a long time to break the strong password. For example, t2wahSetyeT4 is not a word in the dictionary, and consists of a number and a letter, 4pRte!ai@3 is not a word in a dictionary, and consists of a punctuation in addition a number and a letter, MoOoOfIn245679 is a password having a long length, and consists of a number and a letter.

After the change time is set, whether a current time arrives at the set change time is detected in a real-time manner, to determine whether to change the connection information, new connection information is designed for each change time after arriving at the set change time, the new connection information is a connection information with respect to the connection information corresponding to a previous change time for the connection information. The algorithm for generating the new connection information is not limited, and a format of the connection information can be preset, for example, a character string consisting of a number, a letter and a symbol can be used. In a case that the current time arrives at the change time for the connection information, the connection information of the wireless network changed at the previous change time for the connection information is replaced with the new connection information corresponding to the change time, thereby changing the connection information of the wireless network on time automatically, saving hand labor, and avoiding limitation of manual change.

In the embodiment, the change time is periodical, and the same connection information or different connection information can be generated at the periodical change time according to a predetermined algorithm. For example, in a case that the set change time is the first, seventh, 14-th, 21-th or 28-th of each month, the same connection information can be generated for January 1 and February 1 according to the predetermined algorithm, alternatively, different connection information can be generated for January 1 and February 1 according to the predetermined algorithm. In a case that different connection information is generated, security of the wireless network is higher.

In step S102, original connection information of the wireless network is replaced with the new connection information corresponding to the change time.

After the new connection information corresponding to the change time is obtained in step S101, the original connection information of the wireless network is replaced with the new connection information. After replacing the original connection information of the wireless network with the newt connection information, the terminal device is unable to be connected to the wireless network by using the original connection information, and the terminal device is reconnected to the wireless network by using the new connection information, the original connection information of the wireless network is replaced with the new connection information periodically.

In step S103, the new connection information is converted into a bar code, so that the terminal device can be connected to the wireless network by scanning the bar code.

Preferably, the bar code is a two-dimensional code. The two-dimensional code is black and white pattern-recorded data symbol information formed by disposing a particular geometry on a plane (in a two-dimensional direction) according to a rule, and the data symbol information is recognized and read automatically by an image inputting device or a photoelectrical scanning device to realize automatic information processing.

In step S103, the new connection information is converted into the two-dimensional code, so that the terminal device can acquire the connection information by scanning the two-dimensional code, and then is connected to the wireless network to be on the Internet.

In a preferable embodiment of the present disclosure, the method may further include transmitting the bar code to a display device in a preset mode, to display the bar code on the display device, the terminal device can be connected to the wireless network by scanning the bar code on the display device.

Specifically, the preset mode includes a wireless communication mode and a wire communication mode. The wireless communication mode may be a Bluetooth connection. After obtaining the bar code, the bar code can be transmitted to the display device in the wireless communication mode or the wire communication mode, to display the bar code on the display device. The terminal device can be connected to the wireless network by scanning the bar code on the display terminal.

The bar code is transmitted to the display device and then is displayed on the display device, therefore, a defect of affecting aesthetic of public places is avoided since the bar code is printed and posted.

With the method provided according to the embodiment of the present disclosure, a change time for the connection information of the wireless network is set, whether a current time arrives at the change time is detected, and new connection information corresponding to the change time is generated according to a predetermined algorithm in a case that the current time arrives at the change time, original connection information of the wireless network is replaced with the new connection information corresponding to the change time, the new connection information is converted into a bar code, so that the terminal device can be connected to the wireless network by scanning the bar code, thereby changing the connection information of the wireless network on time automatically, and saving hand labor, and therefore avoiding limitation of manual change and improving security of the wireless network.

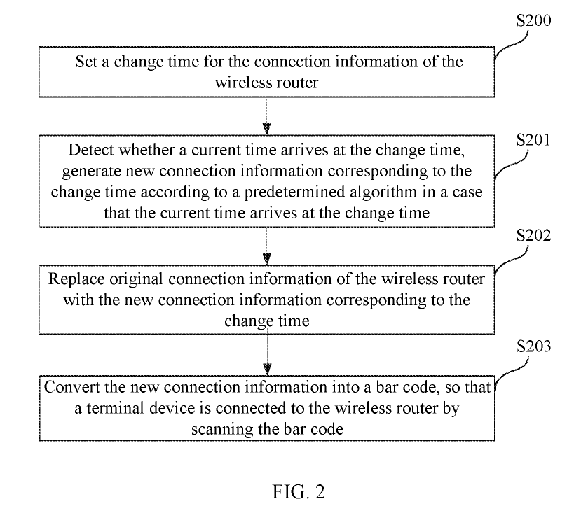

FIG. 2 is a flow diagram of a method for managing connection information of a wireless network according to an embodiment of the present disclosure. A method for managing connection information of a wireless router is introduced in the embodiment, as shown in FIG. 2, the method includes steps S200 to S203.

In step S200, a change time for the connection information of the wireless network is set.

An administrator can log onto a management page for the wireless router via a management device such as a phone and a computer, and set a change time for the connection information of the wireless router in the management page. The security of the wireless router can be improved by changing the connection information of the wireless router.

The change time can be set according to actual cases, and can be adjusted at any time, which is not described repeatedly here any more.

In step S201, whether a current time arrives at the change time is detected, new connection information corresponding to the change time is generated according to a predetermined algorithm in a case that the current time arrives at the change time.

When changing the connection information, only the name of the wireless network or only the password of the wireless network may be changed, or both the name and the password of the wireless network may be changed. Specifically, changing the password of the wireless network may include changing a length of the password or strength of the password of the wireless network.

Whether a current time arrives at the set change time is detected in a real-time manner, to determine whether to change the connection information, new connection information is designed for each change time after arriving at the set change time, the new connection information is connection information with respect to the connection information corresponding to a previous change time for the connection information. The algorithm for generating the new connection information is not limited, and a format of the connection information can be preset, for example, a character string consisting of a number, a letter and a symbol can be used. In a case that the current time arrives at the change time for the connection information, the connection information of the wireless router changed at the previous change time for the connection information is replaced with the new connection information corresponding to the change time, thereby changing the connection information of the wireless router on time automatically, saving hand labor, and avoiding limitation of manual change.

In step S202, original connection information of the wireless router is replaced with the new connection information corresponding to the change time.

After the new connection information corresponding to the change time is obtained in step S201, the original connection information of the wireless router is replaced with the new connection information. After replacing the original connection information of the wireless router with the new connection information, the terminal device is unable to be connected to the wireless router by using the original connection information, and the terminal device is reconnected to the wireless router by using the new connection information, the original connection information of the wireless router is replaced with the new connection information periodically.

After the original connection information is replaced with the new connection information, the new connection information is transmitted to the wireless router, and then is stored in the wireless router, so as to authenticate a user when the user is connected to the wireless router.

In step S203, the new connection information is converted into a bar code, so that the terminal device can be connected to the wireless router by scanning the bar code.

Currently, the user must enter the connection information of the wireless router manually to connect to the wireless router in general. Here, a request to convert the connection information into a bar code is transmitted to the wireless router, the wireless router converts the new connection information into a bar code, displays the bar code on the management page, and transmits the bar code to the display device. The terminal device can be connected to the wireless router by scanning the bar code on the display device for the bar code, to be on the Internet.

With the method provided according to the embodiment of the present disclosure described above, a change time for the connection information of the wireless router is set, whether a current time arrives at the change time is detected, and new connection information corresponding to the change time is generated according to a predetermined algorithm in a case that the current time arrives at the change time, original connection information of the wireless router is replaced with the new connection information corresponding to the change time, the new connection information is converted into a bar code, so that the terminal device can be connected to the wireless router by scanning the bar code, thereby changing the connection information of the wireless router on time automatically, and saving hand labor, and therefore avoiding limitation of manual change and improving security of the wireless network.

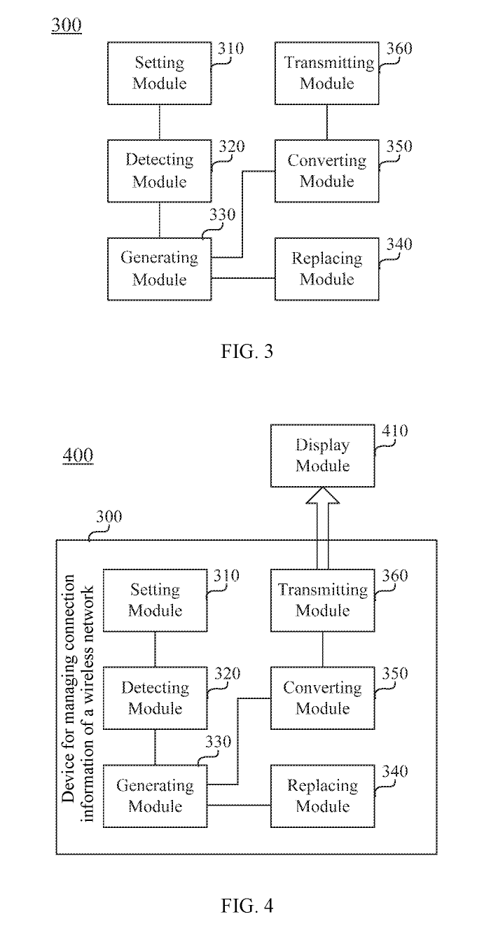

FIG. 3 is a structural block diagram of a device for managing connection information of a wireless network according to an embodiment of the present disclosure. As shown in FIG. 3, the device 300 includes a setting module 310, a detecting module 320, a generating module 330, a replacing module 340, a converting module 350 and a transmitting module 360.

The setting module 310 is configured to set a change time for the connection information of the wireless network.

Specifically, the connection information of the wireless network is information required by a terminal device to connect to a network, and includes a name and a password of the wireless network. The change time for the connection information is periodical.

In order to improve security of the wireless network, the connection information of the wireless network is changed. A way of setting the change time for the connection information of the wireless network is used, in this way, the connection information of the wireless network is changed in a case of arriving at the set change time, the change time may be adjusted based on actual cases, and the change time may be preferably set to as a periodical time. For example, the connection information of the wireless network is changed on the first, seventh, 14-th, 21-th or 28-th of each month, or the connection information of the wireless network is changed on Monday of each week, or the connection information of the wireless network is changed at 12:00 am in a day of the change time, or the change time is an unfixed time, which described above are only exemplary, are not intend to limit.

The detecting module 320 is configured to detect whether a current time arrives at the change time.

After setting the change time, whether the current time arrives at the set change time is detected in a real-time manner, to determine whether to change the connection information.

The generating module 330 is configured to generate new connection information corresponding to the change time according to a predetermined algorithm in a case that the detecting module detects that the current time arrives at the change time.

The changing the connection information may include changing the name of the wireless network and/or changing the password of the wireless network. The changing the password of the wireless network may include changing a length of the password or strength of the password of the wireless network.

After the current time arrives at the set change time, new connection information is designed for each change time, the new connection information is a connection information with respect to the connection information corresponding to a previous change time for the connection information. The algorithm for generating the new connection information is not limited, and a format of the connection information can be preset, for example, a character string consisting of a number, a letter and a symbol can be used. In a case that the current time arrives at the change time for the connection information, the connection information of the wireless network changed at the previous change time for the connection information is replaced with the new connection information corresponding to the change time, thereby changing the connection information of the wireless network on time automatically, saving hand labor, and avoiding limitation of manual change.

The replacing module 340 is configured to replace original connection information with the new connection information corresponding to the change time.

The converting module 350 is configured to convert the new connection information into a bar code, so that a terminal device is connected to the wireless network by scanning the bar code, the bar code is a two-dimensional code.

Optionally, the device may further include a transmitting module 360 configured to transmit the bar code to a display device in a preset mode, to display the bar code on the display device, the terminal device can be connected to the wireless network by scanning the bar code on the display device.

Specifically, the preset mode includes a wireless communication mode and a wire communication mode. The wireless communication mode may be a Bluetooth connection. After obtaining the bar code, the bar code can be transmitted to the display device in the wireless communication mode or the wire communication mode, to display the bar code on the display device. The terminal device can be connected to the wireless network by scanning the bar code on the display terminal.

The bar code is transmitted to the display device and then is displayed on the display device, therefore, a defect of affecting aesthetic of public places is avoided since the bar code is printed and posted.

With the device provided according to the embodiment of the present disclosure, a change time for the connection information of the wireless network is set, whether a current time arrives at the change time is detected, and new connection information corresponding to the change time is generated according to a predetermined algorithm in a case that the current time arrives at the change time, original connection information of the wireless network is replaced with the new connection information corresponding to the change time, the new connection information is converted into a bar code, so that the terminal device can be connected to the wireless network by scanning the bar code, thereby changing the connection information of the wireless network on time automatically, and saving hand labor, and therefore avoiding limitation of manual change and improving security of the wireless network.

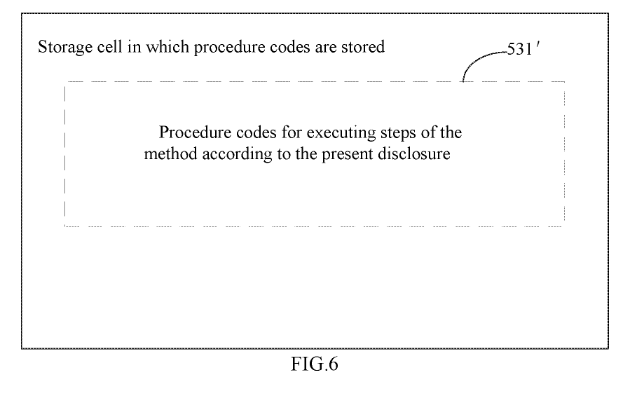

FIG. 4 is a structural block diagram of a system for managing connection information of a wireless network according to an embodiment of the present disclosure. The system 400 may include the device 300 for managing connection information of a wireless network and a display device 410.

The device 300 for managing connection information of a wireless network is configured to transmit the converted bar code to the display device 410, to display the bar code on the display device 410.

With the system provided according to the embodiment of the present disclosure, a change time for the connection information of the wireless network is set, whether a current time arrives at the change time is detected, and new connection information corresponding to the change time is generated according to a predetermined algorithm in a case that the current time arrives at the change time, original connection information of the wireless network is replaced with the new connection information corresponding to the change time, the new connection information is converted into a bar code, so that the terminal device can be connected to the wireless network by scanning the bar code, thereby changing the connection information of the wireless network on time automatically, and saving hand labor, and therefore avoiding limitation of manual change and improving security of the wireless network. The bar code is transmitted to the display device, to display the bar code on the display device, thereby avoiding a defect of affecting aesthetic of public places is avoided since the bar code is printed and posted

Further, an embodiment of the present disclosure provides a non-transitory computer-readable storage medium storing executable instructions which can be used to perform the processing method of the operation of the list items mentioned by any method embodiments of the present disclosure.

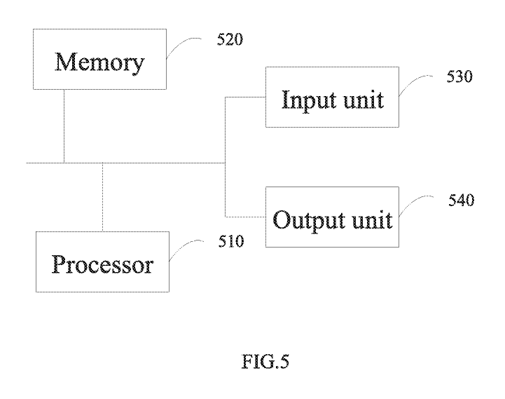

FIG. 5 is a schematic diagram of a hardware structure of the electronic device for implementing a method for managing connection information of a wireless network according to an embodiment of the present disclosure. As shown in FIG. 5, the device includes:

one or more processors 510 and memory 520. A processor 510 is showed in FIG. 5 for an example.

The device for implementing the method for managing connection information of a wireless network can also includes: input unit 530 and output unit 540.

Processor 510, memory 520, input unit 530 and output unit 540 can be connected by BUS or other methods, and BUS connecting is showed in FIG. 5 for an example.

Memory 520 can be used for storing non-transitory software program, non-transitory computer executable program and modules as a non-transitory computer-readable storage medium, such as corresponding program instructions/modules for the methods for managing connection information of a wireless network mentioned by embodiments of the present disclosure (such as shown in FIG. 3, acquiring module 310, computing module 320 and warning module 330). Processor 510 performs kinds of functions and data processing by executing non-transitory software program, instructions and modules which are stored in memory 520, thereby realizes the methods for managing connection information of a wireless network mentioned by embodiments of the present disclosure.

Memory 520 can include program storage area and data storage area, thereby the operating system and applications required by at least one function can be stored in program storage area and data created by using the device for managing connection information of a wireless network can be stored in data storage area. Furthermore, memory 520 can include high speed Random-access memory (RAM) or non-volatile memory such as magnetic disk storage device, flash memory device or other non-volatile solid state storage devices. In some embodiments, memory 520 can include long-distance setup memories relative to processor 510, which can communicate with the device for managing connection information of a wireless network by networks. The examples of said networks are including but not limited to Internet, Intranet, LAN, mobile Internet and their combinations.

Input unit 530 can be used to receive inputted number, character information and key signals causing user configures and function controls of the device for managing connection information of a wireless network. Output unit 540 can include a display screen or a display device.

The said module or modules are stored in memory 520 and perform the methods for managing connection information of a wireless network when executed by one or more processors 510.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-13. (canceled)

14. A method for managing connection information of a wireless network, comprising:
setting a change time for the connection information of the wireless network;
detecting whether a current time arrives at the change time, generating new connection information corresponding to the change time according to a predetermined algorithm in a case that the current time arrives at the change time;
replacing original connection information of the wireless network with the new connection information corresponding to the change time; and
converting the new connection information into a bar code, so that a terminal device is connected to the wireless network by scanning the bar code.

15. The method according to claim 14, further comprising transmitting the bar code to a display device in a preset mode to display the bar code on the display device, the terminal device being connected to the wireless network by scanning the bar code on the display device.

16. The method according to claim 14, wherein the change time for the connection information is periodical.

17. The method according to claim 14, wherein the connection information comprises a name and a password of the wireless network;
changing the connection information comprises changing the name of the wireless network and/or changing the password of the wireless network;
wherein the changing the password of the wireless network comprises changing a length of the password or strength of the password of the wireless network.

18. The method according to claim 14, wherein the bar code is a two-dimensional code.

19. The method according to claim 15, wherein the present mode comprises a wireless communication mode and a wire communication mode.

20. An electronic device for connection information of a wireless network, comprising:
at least one processor; and
a memory communicably connected with the at least one processor for storing instructions executable by the at least one processor, wherein execution of the instructions by the at least one processor causes the at least one processor to:
set a change time for the connection information of the wireless network;
detect whether a current time arrives at the change time, and new connection information corresponding to the change time is generated according to a predetermined algorithm in a case that the current time arrives at the change time;
replace original connection information of the wireless network with the new connection information corresponding to the change time;
convert the new connection information into a bar code, so that the terminal device is connected to the wireless network by scanning the bar code.

21. The electronic device according to claim 20, the at least one processor is further caused to transmit the bar code to a display device in a preset mode to display the bar code on the display device, the terminal device being connected to the wireless network by scanning the bar code on the display device.

22. The electronic device according to claim 20, wherein the change time for the connection information is periodical.

23. The electronic device according to claim 20, wherein the connection information comprises a name and a password of the wireless network;
change the connection information comprises change the name of the wireless network and/or change the password of the wireless network;
wherein the change the password of the wireless network comprises change a length of the password or strength of the password of the wireless network.

24. The electronic device according to claim 20, wherein the bar code is a two-dimensional code.

25. The electronic device according to claim 21, wherein the preset mode comprises a wireless communication mode and a wire communication mode.

26. A non-transitory computer-readable storage medium storing executable instructions that, when executed by an electronic device, cause the electronic device to:
set a change time for the connection information of the wireless network;
detect whether a current time arrives at the change time, and new connection information corresponding to the change time is generated according to a predetermined algorithm in a case that the current time arrives at the change time;
replace original connection information of the wireless network with the new connection information corresponding to the change time;
convert the new connection information into a bar code, so that the terminal device is connected to the wireless network by scanning the bar code.

27. The non-transitory computer-readable storage medium according to claim 26, wherein electronic device is further caused to: transmit the bar code to a display device in a preset mode to display the bar code on the display device, the terminal device being connected to the wireless network by scanning the bar code on the display device.

28. The non-transitory computer-readable storage medium according to claim 26, wherein the change time for the connection information is periodical.

29. The non-transitory computer-readable storage medium according to claim 26, wherein the connection information comprises a name and a password of the wireless network;
change the connection information comprises change the name of the wireless network and/or change the password of the wireless network;
wherein the change the password of the wireless network comprises change a length of the password or strength of the password of the wireless network.

30. The non-transitory computer-readable storage medium according to claim 26, wherein the bar code is a two-dimensional code.

31. The non-transitory computer-readable storage medium according to claim 27, wherein the present mode comprises a wireless communication mode and a wire communication mode.
